(19) United States
(12) Patent Application Publication
(10) Pub. No.: US 2008/0252561 A1
(43) Pub. Date: Oct. 16, 2008

(54) PLASMA DISPLAY APPARATUS

(76) Inventors: Junghyun LEE, Gumi-city (KR); Donghyuk Park, Gumi-city (KR); Choonsub Kim, Gumi-city (KR)

Correspondence Address: KED & ASSOCIATES, LLP, P.O. Box 221200, Chantilly, VA, 20153-1200, US

(21) Appl. No.: 12/102,325

(22) Filed: Apr. 14, 2008

(30) Foreign Application Priority Data
Apr. 13, 2007 (KR) 10-2007-0036532

(51) Int. Cl. G09G 3/28

(52) U.S. Cl. 345/60

(57) ABSTRACT

A plasma display apparatus is disclosed. The plasma display apparatus includes a scan electrode and a sustain electrode positioned parallel to each other, and an address electrode positioned to intersect the scan electrode and the sustain electrode. A reset signal is supplied to the scan electrode, and a first bias signal is supplied to the address electrode to overlap the reset signal. A voltage magnitude of the first bias signal satisfies the following Equation: 0.15 g≦ΔV≦0.6 g, where ΔV is a magnitude of a highest voltage of the first bias signal in unit of volt, and g is an interval between the scan electrode and the sustain electrode in unit of μm.

This application claims the benefit of Korean Patent Application No. 10-2007-0036532 filed on Apr. 13, 2007, which is hereby incorporated by reference.

### BACKGROUND

1. Field

An exemplary embodiment relates to a plasma display apparatus.

2. Description of the Related Art

A plasma display apparatus includes a plasma display panel.

A plasma display panel includes a phosphor layer inside discharge cells partitioned by barrier ribs and a plurality of electrodes.

When driving signals are applied to the electrodes of the plasma display panel, a discharge occurs inside the discharge cells. In other words, when the plasma display panel is discharged by applying the driving signals to the discharge cells, a discharge gas filled in the discharge cells generates vacuum ultraviolet rays, which thereby cause phosphors positioned between the barrier ribs to emit light, thus producing visible light. An image is displayed on the screen of the plasma display panel due to the visible light.

### SUMMARY

In one aspect, a plasma display apparatus comprises a scan electrode and a sustain electrode positioned parallel to each other, and an address electrode positioned to intersect the scan electrode and the sustain electrode, wherein a reset signal is supplied to the scan electrode, and a first bias signal is supplied to the address electrode to overlap the reset signal, wherein a voltage magnitude of the first bias signal satisfies the following Equation: 0.15 g≦ΔV≦0.6 g, where ΔV is a magnitude of a highest voltage of the first bias signal in unit of volt, and g is an interval between the scan electrode and the sustain electrode in unit of μm.

In another aspect, a plasma display apparatus comprises a scan electrode and a sustain electrode positioned parallel to each other, and an address electrode positioned to intersect the scan electrode and the sustain electrode, wherein a reset signal is supplied to the scan electrode, a first bias signal is supplied to the address electrode to overlap the reset signal, a plurality of sustain signals are supplied to at least one of the scan electrode and the sustain electrode, and a second bias signal is supplied to the address electrode to overlap the sustain signals.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1 shows a structure of a plasma display panel of a plasma display apparatus according to an exemplary embodiment;

FIG. 2 is a diagram for explaining in detail a scan electrode and a sustain electrode;

FIG. 3 shows a frame for achieving a gray scale of an image in the plasma display apparatus;

FIG. 4 is a diagram for explaining an example of an operation of the plasma display apparatus in any subfield of a frame;

FIGS. 5A and 5B is a diagram for explaining an example of a function of a first bias signal;

FIG. 6A is a diagram for explaining a relationship between a first bias signal and an interval between scan and sustain electrodes;

FIG. 6B is a diagram for explaining an interval between scan and sustain electrodes each having an ITO-less electrode structure;

FIG. 7 is a table for explaining a relationship between a voltage magnitude of a first bias signal and an interval between scan and sustain electrodes;

FIG. 8 is a diagram for explaining another example of a first bias signal;

FIG. 9 is a diagram for explaining another example of an operation of the plasma display apparatus in any subfield of a frame;

FIG. 10 is a diagram for explaining another example of a second bias signal;

FIG. 11 is a diagram for explaining still another example of a second bias signal; and

FIG. 12 is a diagram for explaining another example of a sustain signal.

### DETAILED DESCRIPTION

Reference will now be made in detail embodiments of the invention examples of which are illustrated in the accompanying drawings.

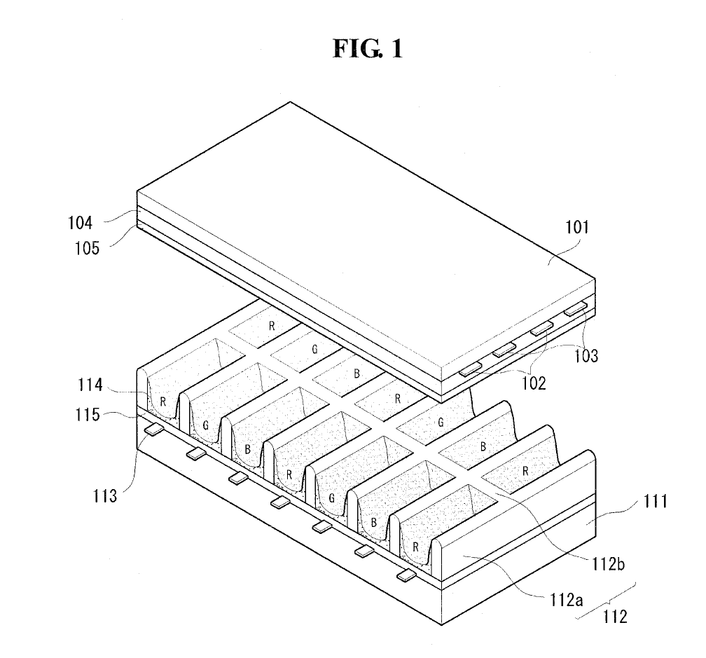

FIG. 1 shows a structure of a plasma display panel of a plasma display apparatus according to an exemplary embodiment.

As shown in FIG. 1, the plasma display panel of the plasma display apparatus according to the exemplary embodiment includes a front substrate 101 and a rear substrate 111 positioned opposite the front substrate 101 which coalesce each other. A scan electrode 102 and a sustain electrode 103 are positioned parallel to each other on the front substrate 101. An address electrode 113 is positioned on the rear substrate 111 to intersect the scan electrode 102 and the sustain electrode 103.

An upper dielectric layer 104 is positioned on the front substrate 101, on which the scan electrode 102 and the sustain electrode 103 are positioned, to cover the scan electrode 102 and the sustain electrode 103. The upper dielectric layer 104 can limit a discharge current of the scan electrode 102 and the sustain electrode 103 and provide electrical insulation between the scan electrode 102 and the sustain electrode 103.

A protective layer 105 may be positioned on the upper dielectric layer 104 to facilitate discharge conditions.

A lower dielectric layer 115 is positioned on the rear substrate 111, on which the address electrode 113 is positioned, to cover the address electrode 113. The lower dielectric layer 115 can provide electrical insulation of the address electrodes 113.

Barrier ribs 112 of a stripe type, a well type, a delta type, a honeycomb type, and the like, may be positioned on the lower dielectric layer 115 to partition discharge spaces (i.e., discharge cells). A red (R) discharge cell, a green (G) discharge cell, and a blue (B) discharge cell, and the like, may be positioned between the front substrate 101 and the rear substrate 111.

Each discharge cell partitioned by the barrier ribs 112 may be filled with a predetermined discharge gas.

A phosphor layer 114 may be positioned inside the discharge cells to emit visible light for an image display during an address discharge. For instance, a red (R) phosphor layer, a green (G) phosphor layer, and a blue (B) phosphor layer may be positioned.

A black matrix (not shown) capable of absorbing external light may be positioned on the barrier rib 112 so as to prevent the external light from being reflected by the barrier rib 112. The black matrix may be positioned on the front substrate 101 at a predetermined location corresponding to the barrier rib 112.

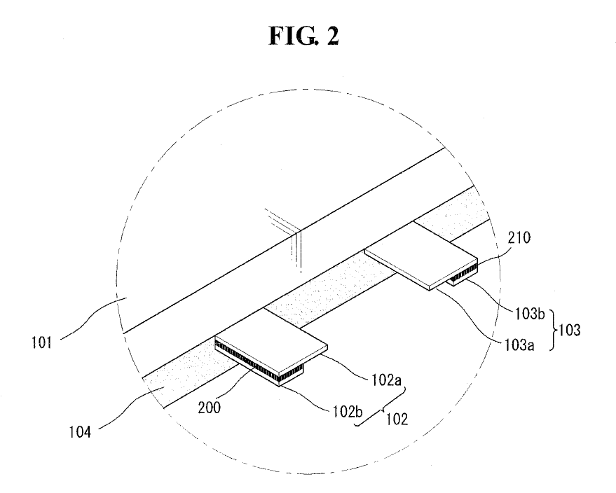

FIG. 2 is a diagram for explaining in detail a scan electrode and a sustain electrode.

As shown in FIG. 2, each of the scan electrode 102 and the sustain electrode 103 may have a multi-layered structure. For instance, the scan electrode 102 and the sustain electrode 103 each include transparent electrodes 102a and 103a and bus electrodes 102b and 103b.

The bus electrodes 102b and 103b may include a substantially opaque material, for instance, silver (Ag), gold (Au), and aluminum (Al). The transparent electrodes 102a and 103a may include a substantially transparent material, for instance, indium-tin-oxide (ITO).

Black layers 200 and 210 may be formed between the transparent electrodes 102a and 103a and the bus electrodes 102b and 103b so as to prevent external light from being reflected by the bus electrodes 102b and 103b.

The scan electrode 102 and the sustain electrode 103 may have only the bus electrodes 102b and 103b. The scan electrode 102 and the sustain electrode 103 may be called an ITO-less electrode in which the transparent electrodes 102a and 103a are omitted.

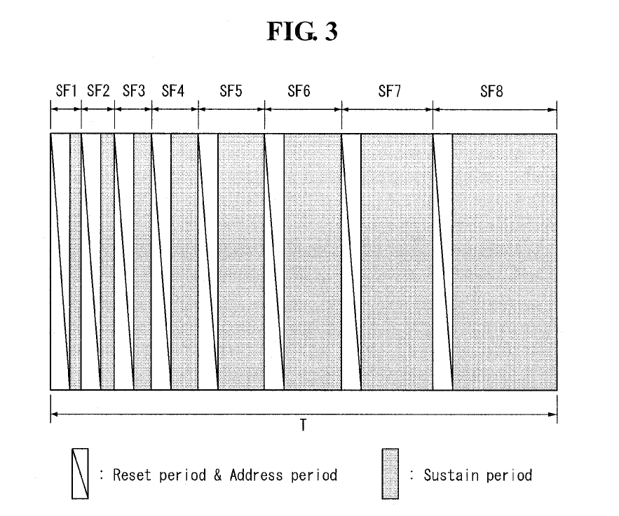

FIG. 3 shows a frame for achieving a gray scale of an image in the plasma display apparatus.

As shown in FIG. 3, a frame for achieving a gray scale of an image displayed by the plasma display apparatus may be divided into a plurality of subfields each having a different number of emission times.

Although it is not shown, at least one of the plurality of subfields may be subdivided into a reset period for initializing the discharge cells, an address period for selecting cells to be discharged, and a sustain period for representing a gray scale depending on the number of discharges.

For example, if an image with 256-level gray scale is to be displayed, a frame is divided into 8 subfields SF1 to SF8 as shown in FIG. 3. Each of the 8 subfields SF1 to SF8 is subdivided into a reset period, an address period, and a sustain period.

A weight value of each subfield may be set depending on the number of sustain signals supplied during the sustain period. In other words, a predetermined weight value may be assigned to each subfield depending on a length of the sustain period. For example, in such a method of setting a weight value of a first subfield at 2⁰ and a weight value of a second subfield at 2¹, a weight value of each subfield may be set so that a weight value of each subfield increases in a ratio of 2ⁿ (where, n=0, 1, 2, 3, 4, 5, 6, 7). Various images with various gray scales can be displayed by adjusting the number of sustain signals supplied during a sustain period of each subfield depending on a weight value of each subfield.

The plasma display apparatus uses a plurality of frames to display an image for one second. For instance, 60 frames are used to display an image for one second. In this case, a length T of the frame may be 1/60 second (i.e., 16.67 ms).

Although FIG. 3 has shown and described the case where one frame includes 8 subfields, the number of subfields constituting one frame may vary.

Further, although FIG. 3 has shown and described the subfields arranged in increasing order of weight values, the subfields may be arranged in decreasing order of weight values or regardless of weight values.

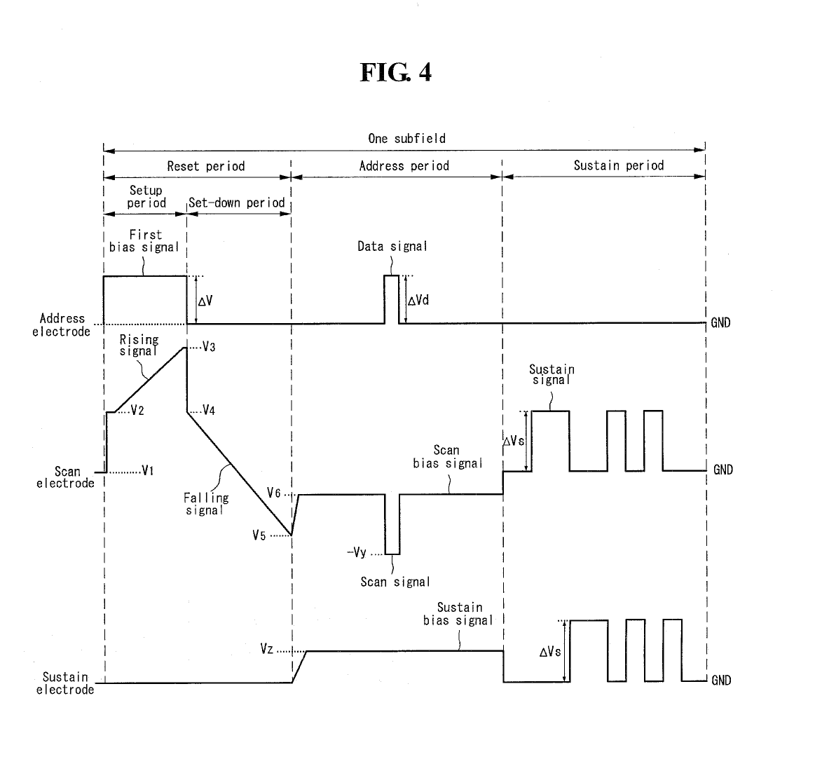

FIG. 4 is a diagram for explaining an example of an operation of the plasma display apparatus in any subfield of a frame.

As shown in FIG. 4, during a reset period for initialization, a reset signal may be supplied to the scan electrode. The reset signal may include a rising signal and a falling signal. The reset period is further divided into a setup period and a set-down period.

During the setup period, the rising signal may be supplied to the scan electrode. The rising signal rises from a first voltage V1 to a second voltage V2, and then gradually rises from the second voltage V2 to a third voltage V3. The first voltage V1 may be a ground level voltage. The supply of the rising signal generates a weak dark discharge (i.e., a setup discharge) inside the discharge cell. Hence, a proper amount of wall charges may be accumulated inside the discharge cell.

During the set-down period, the falling signal of a polarity opposite a polarity of the rising signal may be supplied to the scan electrode. The falling signal gradually falls from a fourth voltage V4 lower than a peak voltage (i.e., the third voltage V3) of the rising signal to a fifth voltage V5. The supply of the falling signal generates a weak erase discharge (i.e., a set-down discharge) inside the discharge cell. Hence, the remaining wall charges are uniform inside the discharge cells to the extent that an address discharge can occur stably.

A first bias signal is supplied to the address electrode during the reset period. The first bias signal has a voltage magnitude ΔV and may overlap the rising signal.

During an address period following the reset period, a scan bias signal, which is substantially maintained at a sixth voltage V6 higher than the lowest voltage V5 of the falling signal, may be supplied to the scan electrode. A scan signal falling from the scan bias signal to a voltage −Vy may be supplied to the scan electrode. When the scan signal is supplied to the scan electrode, a data signal having a voltage magnitude ΔVd may be supplied to the address electrode so as to overlap the scan signal. As the voltage difference between the scan signal and the data signal is added to the wall voltage produced during the reset period, an address discharge occurs inside the discharge cell to which the data signal is supplied.

A sustain bias signal may be supplied to the sustain electrode during the address period so as to prevent the address discharge from unstably occurring by interference of the sustain electrode. The sustain bias signal may be substantially maintained at a sustain bias voltage Vz. The sustain bias voltage Vz is lower than a voltage Vs of a sustain signal to be supplied during a sustain period and is higher than the ground level voltage GND.

During a sustain period following the address period, the sustain signal may be supplied to at least one of the scan electrode or the sustain electrode. For instance, the sustain signals may be alternately supplied to the scan electrode and the sustain electrode.

As the wall voltage inside the discharge cell selected by performing the address discharge is added to the sustain voltage Vs of the sustain signal, every time the sustain signal is supplied, a sustain discharge, i.e., a display discharge occurs between the scan electrode and the sustain electrode.

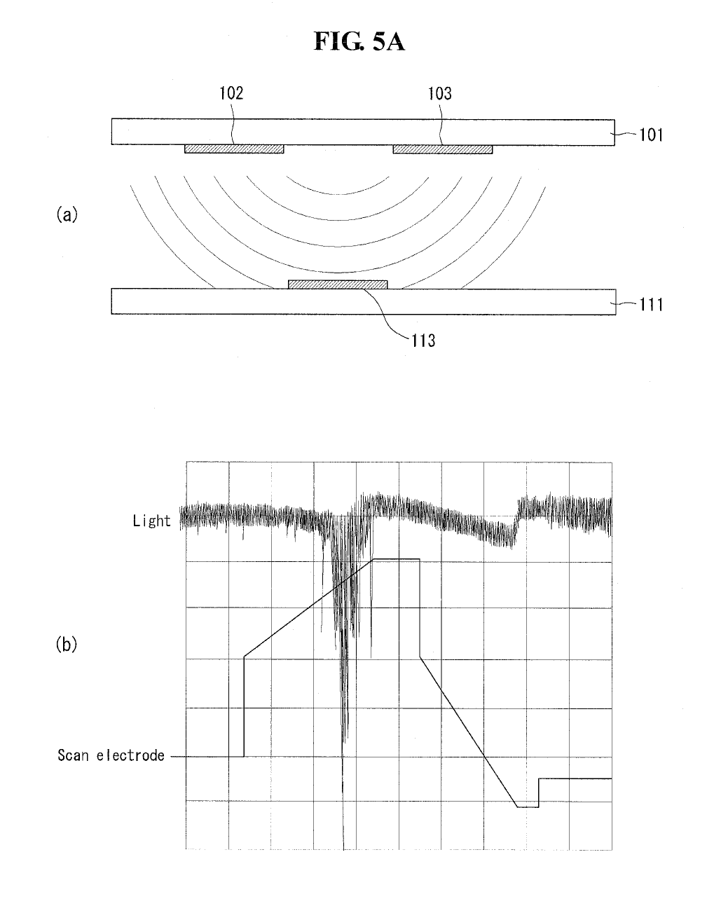

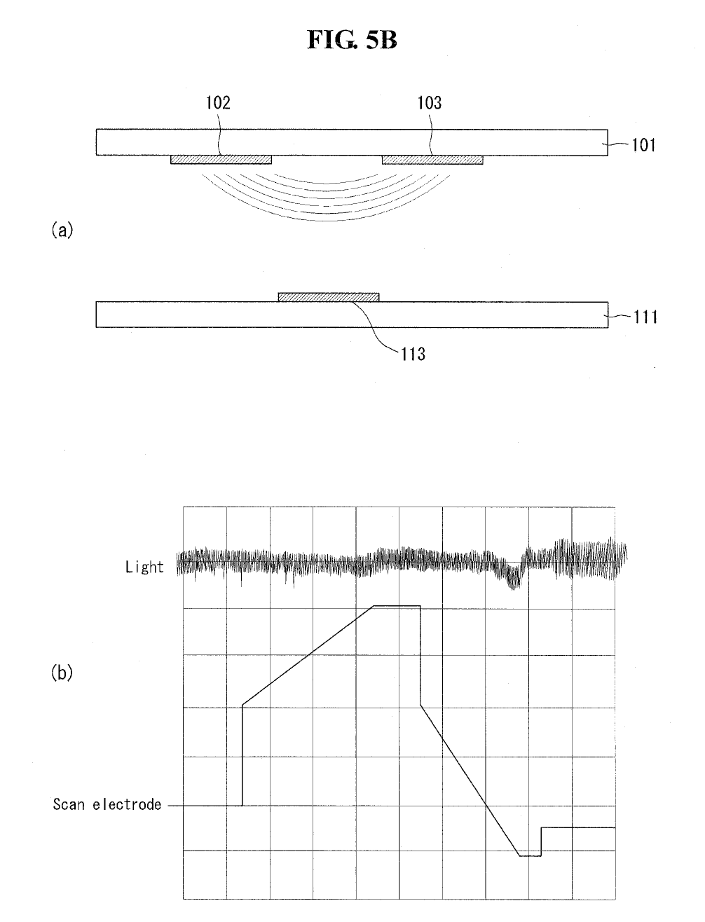

FIGS. 5A and 5B is a diagram for explaining an example of a function of a first bias signal.

As shown in FIG. 5A, (a) shows the case where a first bias signal is not supplied to the address electrode 113 during a reset period. It is assumed that a discharge occurs between the scan electrode 102 and the sustain electrode 103 by supplying the reset signal to the scan electrode 102. In this case, a discharge generated between the scan electrode 102 and the sustain electrode 103 may strongly travel toward the rear substrate 111 on which the address electrode 113 is positioned. As a result, the phosphor layer (not shown) positioned on the rear substrate 111 may be rapidly degraded, and thus life span of the phosphor layer may be reduced. Further, image sticking or spots may be generated in an image displayed on the screen.

If the discharge generated between the scan electrode 102 and the sustain electrode 103 may travel toward the address electrode 113, an unwanted discharge may occur between the scan electrode 102 and the address electrode 113 or between the sustain electrode 103 and the address electrode 113. For instance, as shown in (b) of FIG. 5A, a very strong discharge may occur between the scan electrode 102 and the address electrode 113. As a result, the wall charges may be unstably distributed inside the discharge cell, and the generated discharge may be unstable. Further, the amount of light generated during the reset period sharply increases, and thus a contrast characteristic and the image quality may worsen.

As shown in FIG. 5B, (a) shows the case where a first bias signal is supplied to the address electrode 113 during a reset period. When a discharge occurs between the scan electrode 102 and the sustain electrode 103 during the reset period, the first bias signal can reduce a voltage difference between the scan electrode 102 and the address electrode 113 and a voltage difference between the sustain electrode 103 and the address electrode 113.

The discharge generated between the scan electrode 102 and the sustain electrode 103 is close to the scan electrode 102 and the sustain electrode 103, and thus the generation of the image sticking and the spots can be prevented and the image quality can be improved. Further, a stable discharge can occur between the scan electrode 102 and the address electrode 113 during the reset period. Hence, the amount of light generated during the reset period may be sufficiently reduced, and the contrast characteristic can be improved.

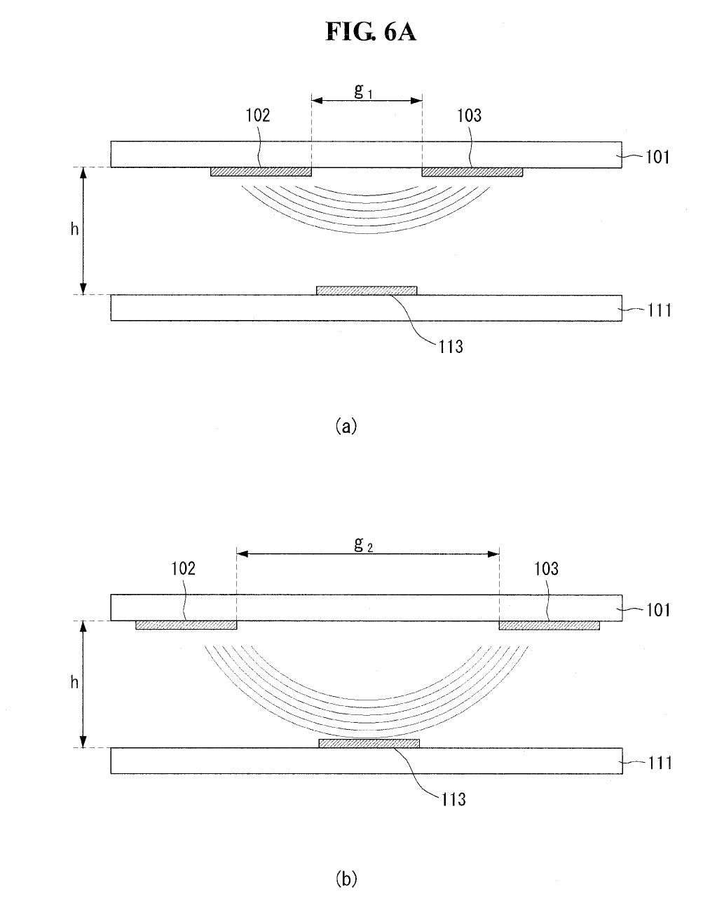

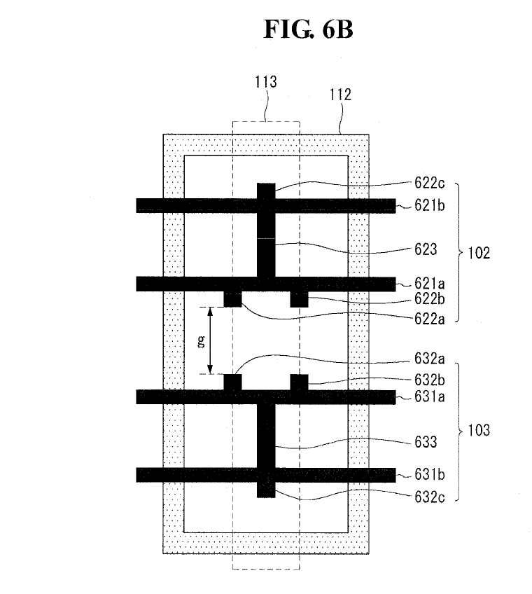

FIG. 6A is a diagram for explaining a relationship between a first bias signal and an interval between scan and sustain electrodes.

As shown in FIG. 6A, (a) shows the case where an interval g1 between the scan electrode 102 and the sustain electrode 103 is relatively narrow. In this case, a path of a discharge generated between the scan electrode 102 and the sustain electrode 103 may be sufficiently short because of the narrow interval g1. Further, the discharge may occur sufficiently close to a direction toward the front substrate 101. Accordingly, the interval g1 between the scan electrode 102 and the sustain electrode 103 is relatively narrow, a voltage magnitude of the first bias signal may be relatively small.

On the contrary, as shown in (b) of FIG. 6A, in case an interval g2 between the scan electrode 102 and the sustain electrode 103 is relatively wide, the drive efficiency can be improved because a positive column region can be sufficiently used during a drive. Hence, the drive efficiency can be improved.

However, a path of a discharge generated between the scan electrode 102 and the sustain electrode 103 may be long. Therefore, the discharge may occur close to a direction toward the rear substrate 111 more frequently than the case of (a) of FIG. 6A

Further, in this case, because the interval g2 between the scan electrode 102 and the sustain electrode 103 is excessively large than an interval h between the front substrate 101 and the rear substrate 111, there may be a great likelihood of the generation of a relatively strong discharge between the scan electrode 102 and the address electrode 113. Therefore, a voltage magnitude of the first bias signal in the case of (b) of FIG. 6A may be relatively larger than that in the case of (a) of FIG. 6A.

Considering the description of FIG. 6A, the voltage magnitude of the first bias signal supplied to the address electrode 113 during the reset period may be changed in consideration of the interval between the scan electrode 102 and the sustain electrode 103.

The interval between the scan electrode 102 and the sustain electrode 103 may lie substantially in a range between 100 μm and 400 μm or between 110 μm and 250 μm.

Supposing that a height h of the barrier rib is 120 μm, the height h of the barrier rib and an interval g between the scan electrode 102 and the sustain electrode 103 may satisfy the following Equation 1.

0.83h≦g≦3.33h [Equation 1]

The height h of the barrier rib and the interval g between the scan electrode 102 and the sustain electrode 103 may satisfy the following Equation 2.

0.92h≦g≦2.08h [Equation 2]

In case the scan electrode 102 and the sustain electrode 103, as shown in FIG. 2, include the transparent electrodes 102a and 103a, the interval g between the scan electrode 102 and the sustain electrode 103 may be an interval between the transparent electrode 102a of the scan electrode 102 and the transparent electrode 103a of the sustain electrode 103.

Accordingly, when the interval between the transparent electrode of the scan electrode and the transparent electrode of the sustain electrode lies in a range between 100 μM and 400 μm or the above equation 1 is satisfied, a discharge occurs in the positive column region of the discharge cell. Hence, the drive efficiency can be improved.

Further, when the interval between the transparent electrode of the scan electrode and the transparent electrode of the sustain electrode lies in a range between 110 μm and 250 μm or the above equation 2 is satisfied, the drive efficiency can be further improved.

FIG. 6B is a diagram for explaining an interval between scan and sustain electrodes each having an ITO-less electrode structure.

As shown in FIG. 6B, the scan electrode 102 may include a plurality of line portions 621a and 621b intersecting the address electrode 113, and projecting portions 622a, 622b and 622c projecting from at least one of the line portions 621a and 621b. The sustain electrode 103 may include a plurality of line portions 631a and 631b intersecting the address electrode 113, and projecting portions 632a, 632b and 632c projecting from at least one of the line portions 631a and 631b. The scan electrode 102 may include a connection portion 623 for connecting the line portions 621a and 621b, and the sustain electrode 103 may include a connection portion 633 for connecting the line portions 631a and 631b.

In FIG. 6B, the scan electrode 102 and the sustain electrode 103 each include three projecting portions. However, the number of projecting portions is not limited thereto. For instance, each of the scan electrode 102 and the sustain electrode 103 may include two projecting portions. The scan electrode 102 may include four projecting portions, and the sustain electrode 103 may include three projecting portions. Further, the projecting portions 622c and 632c may be omitted from the scan electrode 102 and the sustain electrode 103, respectively.

At least one of the projecting portions 622a, 622b, 622c, 632a, 632b and 632c projects from the line portions 621a, 621b, 631a and 631b toward the center of the discharge cell. For instance, the projecting portions 622a and 622b of the scan electrode 102 project from the first line portion 621a of the scan electrode 102 toward the center of the discharge cell, and the projecting portions 632a and 632b of the sustain electrode 103 project from the first line portion 631a of the sustain electrode 103 toward the center of the discharge cell.

In case the scan electrode 102 and the sustain electrode 103 each have the ITO-less electrode structure in which the transparent electrode is omitted, the interval g between the scan electrode 102 and the sustain electrode 103 means an interval between the projecting portions 622a and 622b of the scan electrode 102 and the projecting portions 632a and 632b of the sustain electrode 103.

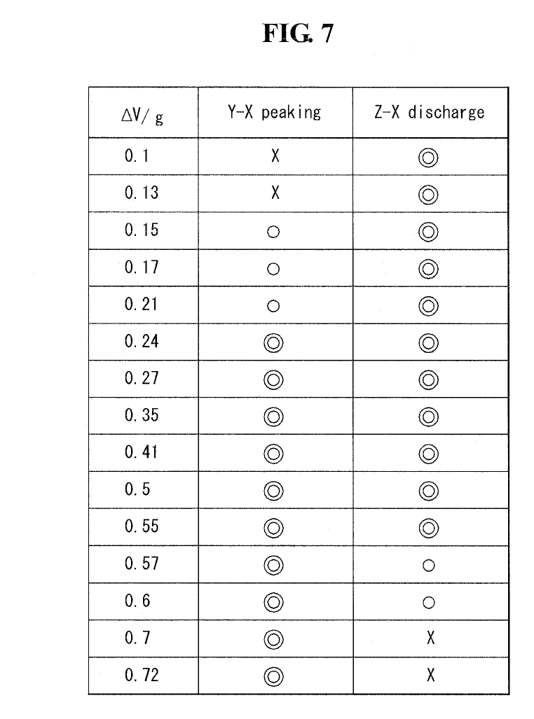

FIG. 7 is a table for explaining a relationship between a voltage magnitude of a first bias signal and an interval between scan and sustain electrodes.

More specifically, FIG. 7 is a graph measuring a peaking occurrence between the scan and address electrodes during a reset period and a state of a discharge generated between the sustain and address electrodes when a ratio ΔV/g of a voltage magnitude ΔV of the first bias signal to an interval g between the scan and sustain electrodes changes in a state where the interval g is fixed at about 180 μm.

In FIG. 7, X indicates that a peaking occurs between the scan and address electrodes or a relatively strong discharge occurs between the sustain and address electrodes; ∘ indicates a good state; and ⊚ indicates that a peaking does not occur between the scan and address electrodes or a discharge does not occur between the sustain and address electrodes.

When the ratio ΔV/g is 0.1 to 0.13, a voltage difference between the scan and address electrodes during the reset period is not sufficiently reduced because the voltage magnitude ΔV of the first bias signal is excessively small. Hence, a relatively strong discharge may occur between the scan and address electrodes, and as shown in (b) of FIG. 5A, a peaking may occur. In this case, a contrast characteristic may worsen.

When the ratio ΔV/g is 0.15 to 0.21, a good state can be obtained because the voltage magnitude ΔV of the first bias signal is proper. In this case, the peaking may occur, but the contrast characteristic does not sharply worsen because an intensity of the generated peaking is small.

When the ratio ΔV/g is 0.24 to 0.72, a voltage difference between the scan and address electrodes during the reset period is sufficiently reduced because the voltage magnitude ΔV of the first bias signal is sufficiently large. Hence, a stable discharge may occur between the scan and address electrodes, and as shown in (b) of FIG. 5B, a peaking does not occur. In this case, the contrast characteristic may be very good.

When the ratio ΔV/g is 0.1 to 0.55, a voltage difference between the sustain and address electrodes during the reset period is sufficiently reduced because the voltage magnitude ΔV of the first bias signal is sufficiently small. Hence, a discharge does not occur between the sustain and address electrodes. In this case, because the discharge does not occur between the sustain and address electrodes, the wall charges can be very stably distributed inside the discharge cell.

When the ratio ΔV/g is 0.57 to 0.6, a good state can be obtained because the voltage magnitude ΔV of the first bias signal is proper. In this case, a weak discharge may occur between the sustain and address electrodes, but a distribution state of wall charges inside the discharge cell does not largely change because an intensity of the generated discharge is small.

When the ratio ΔV/g is 0.7 to 0.72, a voltage difference between the sustain and address electrodes during the reset period is excessively large because the voltage magnitude ΔV of the first bias signal is excessively large. Hence, a relatively strong discharge may occur between the sustain and address electrodes. In this case, the wall charges can be very unstably distributed inside the discharge cell because of the discharge generated between the sustain and address electrodes. Further, a reset discharge may unstably occur because of the unstable distribution state of wall charges inside the discharge cell, and the drive efficiency may be reduced.

Considering the description of FIG. 7, the voltage magnitude ΔV of the first bias signal may satisfy the following equation 3.

0.15 g≦ΔV≦0.6 g [Equation 3]

The voltage magnitude ΔV of the first bias signal may satisfy the following equation 4.

0.24 g≦ΔV≦0.55 g [Equation 4]

As above, when the above equation 3 or 4 is satisfied, the discharge generated between the scan and sustain electrodes can be prevented from being close to the address electrode even if the interval between the scan and sustain electrodes is wide.

Further, because the interval between the scan and sustain electrodes can be sufficiently widened, the positive column region during the drive can be sufficiently used and the drive efficiency can be further improved.

The interval between the scan and sustain electrodes may lie substantially in a range between 100 μm and 400 μm or between 110 μm and 250 μm so as to sufficiently use the positive column region and improve the drive efficiency.

The voltage magnitude ΔV of the first bias signal may be substantially equal to the voltage magnitude ΔVd of the data signal supplied to the address electrode during the address period. Hence, the voltage of the first bias signal and the voltage of the data signal can be generated using one drive circuit, and thus the manufacturing cost can be reduced.

The first bias signal may be omitted in at least one of a plurality of subfields of a frame. For instance, supposing that a frame includes a total of 12 subfields, the first bias signal may be supplied in the first, fifth, and eighth subfields, and the first bias signal may be omitted in the remaining subfields.

Further, the first bias signal may be supplied in subfields where the rising signal is supplied. For instance, supposing that a frame includes a total of 12 subfields, the rising signal is supplied to the scan electrode during reset periods of the first, fourth, and seventh subfields, and the first bias signal may be supplied to the address electrode in the first, fourth, and seventh subfields. The rising signal and the first bias signal may be omitted in the remaining subfields.

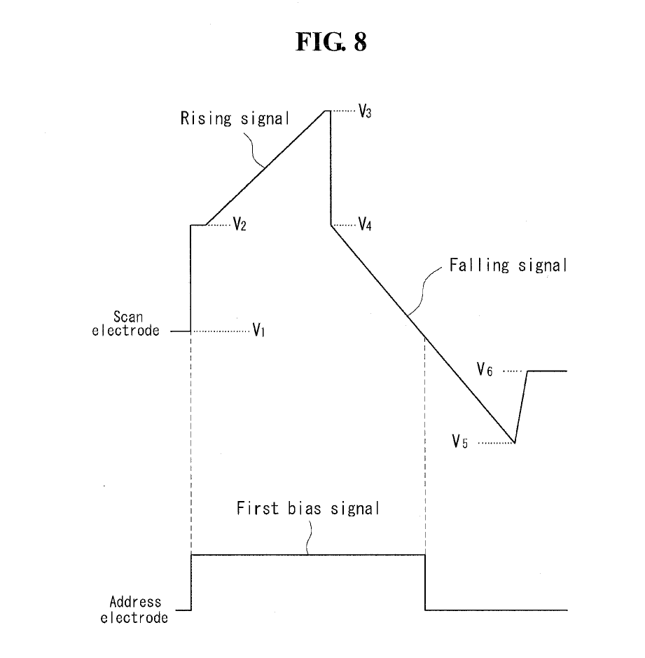

FIG. 8 is a diagram for explaining another example of a first bias signal.

Although FIG. 4 has shown the case where the first bias signal is supplied to overlap only the rising signal during the setup period, the first bias signal may be supplied to commonly overlap the rising signal and the falling signal as shown in FIG. 8.

In this case, it may be advantageous that the first bias signal commonly overlaps the rising signal and the falling signal within a range where a voltage of the falling signal is not excessively low. For instance, if the first bias signal overlaps the falling signal at an excessively low voltage level of the falling signal, a strong discharge may occur between the scan electrode and the address electrode.

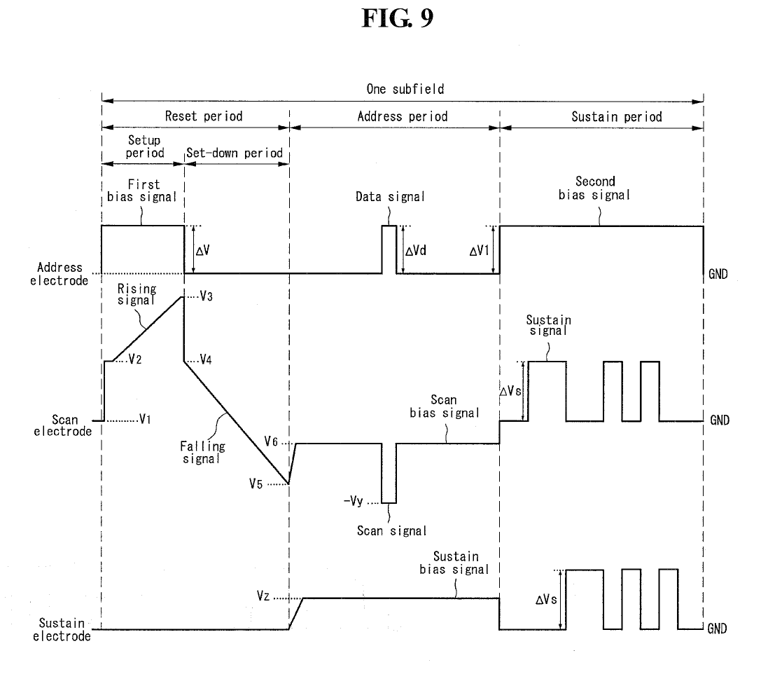

FIG. 9 is a diagram for explaining another example of an operation of the plasma display apparatus in any subfield of a frame.

As shown in FIG. 9, a first bias signal may be supplied to the address electrode to overlap a rising signal supplied to the scan electrode during a reset period, and at the same time, a second bias signal may be supplied to the address electrode to overlap a sustain signal supplied to at least one of the scan electrode or the sustain electrode during a sustain period.

A voltage magnitude ΔV1 of the second bias signal may be substantially equal to or different from a voltage magnitude ΔVd of a data signal supplied to the address electrode during an address period.

The supply of the second bias signal can reduce a voltage difference between the address electrode and the scan electrode and a voltage difference between the address electrode and the sustain electrode during the sustain period. A discharge generated between the scan electrode and the sustain electrode during the sustain period may travel close to the front substrate, and thus the drive efficiency can be improved and the image sticking can be suppressed.

The second bias signal may be omitted in at least one of a plurality of subfields of a frame. For instance, supposing that a frame includes a total of 12 subfields, the second bias signal may be supplied in the first, fifth, and eighth subfields, and the second bias signal may be omitted in the remaining subfields.

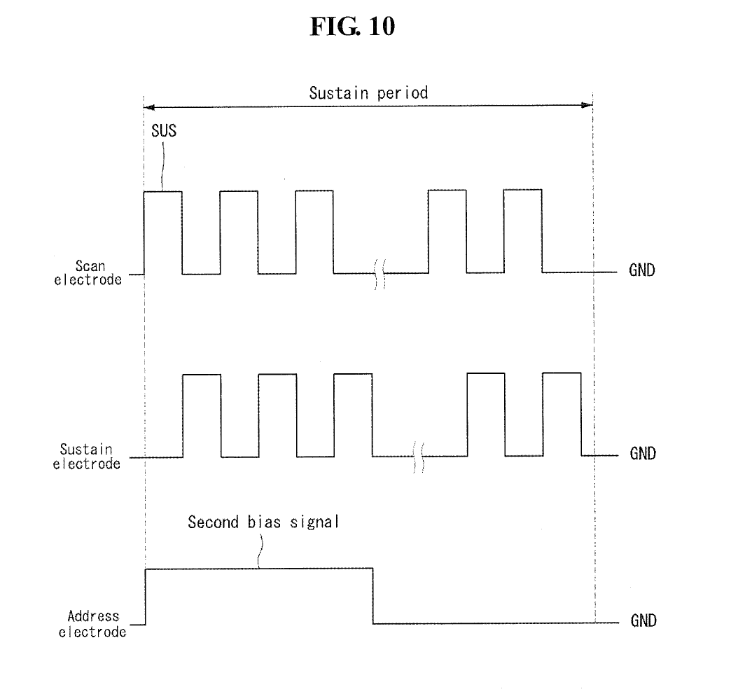

FIG. 10 is a diagram for explaining another example of a second bias signal.

As shown in FIG. 10, in case a plurality of sustain signals SUS are supplied and the second bias signal is supplied to the address electrode during a sustain period, the second bias signal may overlap at least one of the plurality of sustain signals SUS and the second bias signal may not overlap the remaining sustain signals SUS. In other words, a length of the second bias signal may be adjusted.

In case the plasma display apparatus is driven in a single scan drive manner, a considerably long time of period is required to scan all the scan electrode lines. Therefore, wall charges accumulated on the scan electrode during an initial scan operation may be considerably erased as a scan period elapses.

When a first sustain signal is applied to the scan electrode during the initial scan operation, the erase of wall charges may generate not a surface discharge between the scan electrode and the sustain electrode but an opposite discharge between the sustain electrode and the address electrode.

In case an interval between the scan electrode and the sustain electrode is larger than an interval between the scan electrode and the address electrode, an opposite discharge may occur between the scan electrode and the address electrode when the first sustain signal is applied to the scan electrode. Accordingly, when the first sustain signal is applied to the scan electrode, an erroneous discharge can be prevented by supplying the second bias signal to the address electrode.

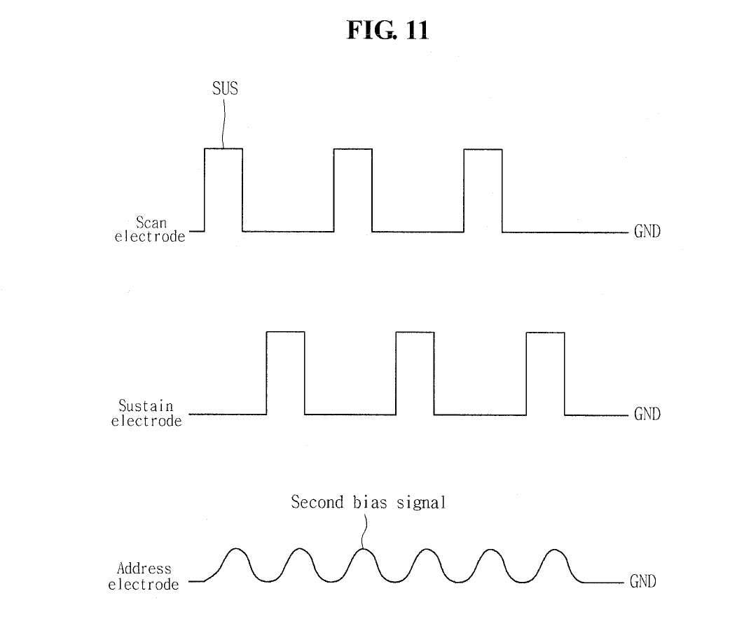

FIG. 11 is a diagram for explaining still another example of a second bias signal.

As shown in FIG. 11, the address electrode is floated during a sustain period, and thus a voltage of the address electrode may rise or fall depending on a sustain signal SUS supplied to at least one of the scan electrode or the sustain electrode. The voltage of the address electrode rising or falling depending on the sustain signal SUS may be the second bias signal. In other words, the second bias signal may be supplied by floating the address electrode during the sustain period.

Because the voltage of the address electrode rises or falls depending on the sustain signal SUS, when the sustain signal SUS is supplied, a voltage difference between the scan electrode and the address electrode and a voltage difference between the sustain electrode and the address electrode may be reduced.

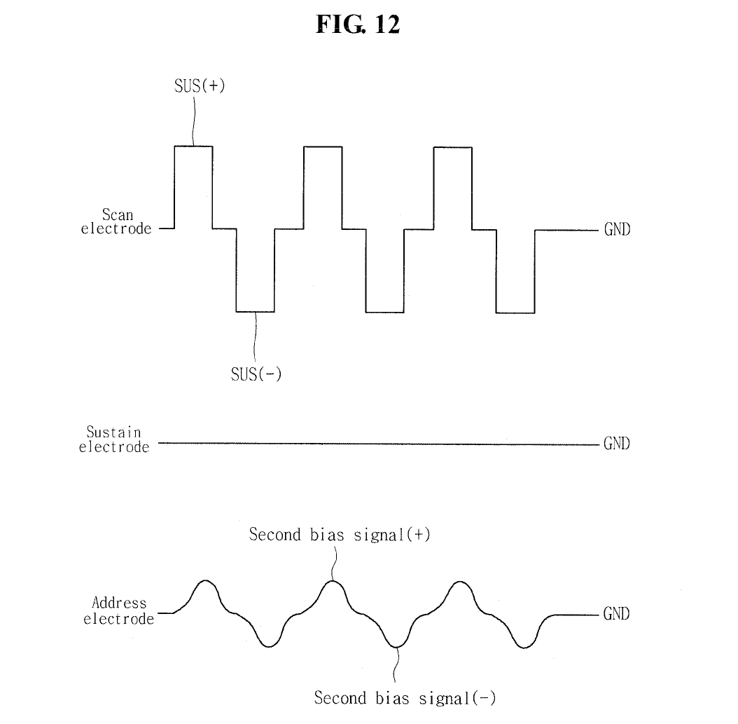

FIG. 12 is a diagram for explaining another example of a sustain signal.

As shown in FIG. 12, sustain signals SUS(+) of a positive polarity and sustain signals SUS(−) of a negative polarity may be alternately supplied to any one of the scan electrode and the sustain electrode, for example, the scan electrode. A ground level voltage GND may be supplied to the other electrode, for example, the sustain electrode during the supply of the sustain signals SUS(+) and SUS(−) to the scan electrode.

In case the sustain signals is supplied to any one of the scan electrode and the sustain electrode, only one drive board on which circuits for supplying the sustain signals are positioned is needed.

In case the sustain signals SUS(+) of the positive polarity and the sustain signals SUS(−) of the negative polarity are alternately supplied to any one of the scan electrode and the sustain electrode, the second bias signal may include a second bias signal of a positive polarity depending on the sustain signals SUS(+) of the positive polarity and a second bias signal of a negative polarity depending on the sustain signals SUS(−) of the negative polarity.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A plasma display apparatus comprising:
a scan electrode and a sustain electrode positioned parallel to each other; and
an address electrode positioned to intersect the scan electrode and the sustain electrode,
wherein a reset signal is supplied to the scan electrode, and a first bias signal is supplied to the address electrode to overlap the reset signal,
wherein a voltage magnitude of the first bias signal satisfies the following Equation: 0.15 g≦ΔV≦0.6 g, where ΔV is a magnitude of a highest voltage of the first bias signal in unit of volt, and g is an interval between the scan electrode and the sustain electrode in unit of μm.

2. The plasma display apparatus of claim 1, wherein the highest voltage magnitude of the first bias signal satisfies the following Equation: 0.24 g≦ΔV≦0.55 g.

3. The plasma display apparatus of claim 1, wherein the interval between the scan electrode and the sustain electrode satisfies the following Equation: 0.83h≦g≦3.33h, where h is a height of a barrier rib of a discharge cell.

4. The plasma display apparatus of claim 1, wherein the interval between the scan electrode and the sustain electrode satisfies the following Equation: 0.92h≦g≦2.08h, where h is a height of a barrier rib of a discharge cell.

5. The plasma display apparatus of claim 1, wherein the scan electrode and the sustain electrode each include a transparent electrode.

6. The plasma display apparatus of claim 5, wherein the interval between the scan electrode and the sustain electrode is an interval between the transparent electrode of the scan electrode and the transparent electrode of the sustain electrode.

7. The plasma display apparatus of claim 1, wherein the scan electrode and the sustain electrode each include a bus electrode, and the interval between the scan electrode and the sustain electrode is an interval between the bus electrode of the scan electrode and the bus electrode of the sustain electrode.

8. The plasma display apparatus of claim 7, wherein the scan electrode and the sustain electrode each include a projecting portion projecting toward the center of a discharge cell, and the interval between the scan electrode and the sustain electrode is an interval between the projecting portion of the scan electrode and the projecting portion of the sustain electrode.

9. The plasma display apparatus of claim 1, wherein the reset signal includes a first rising signal of which a voltage level gradually rises from a first voltage to a second voltage with a first slope, and a second rising signal of which a voltage level gradually rises from the second voltage with a second slope smaller than the first slope.

10. The plasma display apparatus of claim 1, wherein a plurality of sustain signals are supplied to at least one of the scan electrode and the sustain electrode, and a second bias signal is supplied to the address electrode to overlap the sustain signals.

11. The plasma display apparatus of claim 10, wherein the second bias signal is supplied by floating the address electrode.

12. The plasma display apparatus of claim 10, wherein the second bias signal overlaps at least one of the plurality of sustain signals.

13. The plasma display apparatus of claim 1, wherein a scan signal is supplied to the scan electrode, a data signal is supplied to the address electrode to overlap the scan signal, and a magnitude of a highest voltage of the data signal is substantially equal to a magnitude of a highest voltage of the first bias signal.

14. The plasma display apparatus of claim 1, wherein the reset signal includes a rising signal with a gradually rising voltage and a falling signal with a gradually falling voltage, and the first bias signal overlaps the rising signal.

15. The plasma display apparatus of claim 14, wherein the first bias signal partly overlaps the rising signal.

16. The plasma display apparatus of claim 14, wherein the first bias signal partly overlaps the falling signal until a voltage of the falling signal falls to the ground level voltage.

17. A plasma display apparatus comprising:
a scan electrode and a sustain electrode positioned parallel to each other; and
an address electrode positioned to intersect the scan electrode and the sustain electrode,
wherein a reset signal is supplied to the scan electrode, a first bias signal is supplied to the address electrode to overlap the reset signal, a plurality of sustain signals are supplied to at least one of the scan electrode and the sustain electrode, and a second bias signal is supplied to the address electrode to overlap the sustain signals.

18. The plasma display apparatus of claim 17, wherein the second bias signal is supplied by floating the address electrode.

19. The plasma display apparatus of claim 17, wherein the reset signal includes a rising signal with a gradually rising voltage and a falling signal with a gradually falling voltage, and the first bias signal overlaps the rising signal.

20. The plasma display apparatus of claim 17, wherein the second bias signal overlaps at least one of the plurality of sustain signals.
